(19) United States
(12) Patent Application Publication
(10) Pub. No.: US 2011/0283242 A1
(43) Pub. Date: Nov. 17, 2011

(54) REPORT OR APPLICATION SCREEN SEARCHING

(75) Inventors: Kok Thim Chew, San Mateo, CA (US); Cheow Lip Goh, San Jose, CA (US)

(73) Assignee: SAP AG, Walldorf (DE)

(21) Appl. No.: 12/860,417

(22) Filed: Aug. 20, 2010

Related U.S. Application Data
(60) Provisional application No. 61/334,924, filed on May 14, 2010.

(51) Int. Cl. G06F 17/30; G06F 3/033

(52) U.S. Cl. 715/863; 707/769; 707/E17.014; 707/E17.005

(57) ABSTRACT

Search results may be graphically displayed on a client device as thumbnail images. A search for one or more files in the form of a search term may be received from a client device. The search may be executed based on the search term by searching one or more databases corresponding to applications associated with the client device. One or more files may be identified that satisfy the search term. Metadata associated with the identified files may be processed to generate a thumbnail image of the file based at least in part on the metadata for each of the one or more identified files. The thumbnail images of at least a subset of the identified files may be provided to and displayed on the client device. The associated files may be accessed by the client device.

### CROSS-REFERENCE TO RELATED APPLICATIONS

This application claims the benefit of U.S. Provisional Application No. 61/334,924 filed May 14, 2010, the entirety of which is incorporated by reference herein.

### TECHNICAL DESCRIPTION

This disclosure relates generally to methods, software, and systems for browsing and accessing query search results using updateable graphical representations of search result files.

### BACKGROUND

Users can perform searches and queries for information by entering search strings into a computer or other client device. Search queries may be received by a server type device or web application that processes the search string and carries out the search for results. Results may then be returned to the user on his or her computer or device.

### SUMMARY

In some embodiments, a computerized method for graphically displaying search results may be performed by a processor and comprise receiving a search for one or more files in the form of a search term from a client device. The search may be executed based on the search term by searching one or more databases corresponding to applications associated with the client device. In embodiments, one or more search results that satisfy the search term may be identified, and the metadata associated with the identified files may be processed to generate a thumbnail image of the search result based at least in part on the metadata for each of the one or more identified files. The thumbnails of at least a subset of the identified files may be provided to and displayed on the client device.

In some embodiments, a system for graphically displaying query search results may include a memory and at least one processor. The at least one processor may be operable to execute instructions to receive, at a server, a search query for one or more files in the form of a search term from a client device. The processor may execute a search based on the search term by searching one or more databases corresponding to applications associated with the client device. One or more files that satisfy the search term may be identified. In embodiments, the processor may process metadata associated with the identified files and generate a thumbnail image of the file based on the metadata for each of the one or more identified files. The thumbnails of each of at least a subset of the identified files may be provided to and displayed on the client device.

In some embodiments, a computer program product for graphically displaying query search results, which includes computer readable instructions embodied on tangible, non-transient media, is operable when executed to receive at a server a search query for one or more files in the form of a search term from a client device. The computer program product is operable when executed to parse and process the search term using a processor. A search based on the search term may be executed by searching one or more databases corresponding to applications associated with the client device. The computer program product may identify one or more files that satisfy the search term and process metadata associated with the identified files. A thumbnail image of the file may be generated based on the metadata for each of the one or more identified files, and the thumbnails of each of at least a subset of the identified files may be provided to and displayed on the client device.

In certain instances of the embodiments, the search results include one or more reports satisfying the search term, and the thumbnail image of the one or more identified results includes a representation of the one or more reports satisfying the search term.

In certain instances of the embodiments, the thumbnail images displayed on the client device may be updated by processing the metadata associated with the file and generating a new thumbnail. Upon a request from the client device, the new thumbnail may be displayed.

In certain instances of the embodiments, a request for access to a selected file may be received from a client device. Access rights associated with the client device may be processed to determine whether the client device has permission to access the selected file. In certain instances, if the client device has permission to access the selected file, the file is displayed on the client device.

In certain instances of the embodiments, the client device includes an application that is compatible with the file type associated with the selected file, and the file may be communicated to the client device. The application may be launched, and the file may be opened with the application. The file may be displayed on the client device using the application.

In certain instances of the embodiments, a browser plug-in that is compatible with the file type may be identified. In some instances, if the browser includes the browser plug-in, the browser may be launched on the client device and data associated with the selected file may be communicated to the client device. The selected file may be displayed to the client device on the browser.

In certain instances, if the client device does not include an application that is compatible with the file type associated with the selected file, a browser plug-in that is compatible with the file type may be identified. Whether the client device includes a browser with the plug-in may be determined. In some instances, if the browser includes the browser plug-in, the browser may be launched on the client device, data associated with the selected file may be communicated to the client device, and the selected file may be displayed on the client device on the browser. If the browser does not include the plug-in, a private network between the server and the client device may be established. A run-time emulation program may be communicated to the client device. A remote application on the server may be launched, the remote application compatible with the file type associated with the selected file. The file may be displayed on the client device.

In certain instances of the embodiments, a modified file may be received from the client device, the modified file including a modification to a selected file. The modified file may be stored, and the metadata associated with the selected file may be updated with information corresponding to the modification. In certain instances, the modification may be objective or subjective ratings or annotations to the file. In some instances, the modification may be modifications to the metadata based on statistical information concerning the ratings and/or relevancy of a file or file type based on the search query.

In certain instances of the embodiments, a touch-gesture indication may be received from the client device. The touch gesture may be processed by determining the operations associated with the touch gesture, and the operations may be executed. In some embodiments, the touch gesture may be a single touch gesture, or may be a multi-touch gesture.

In certain instances of the embodiments, the thumbnail image of the one or more identified files may display information contained in the one or more files satisfying the search term when displayed on the client device.

While generally described as computer implemented software that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

### DESCRIPTION OF DRAWINGS

FIG. 1 is a schematic showing a system for processing search terms and providing thumbnail images of search results to a client device.

FIG. 2 is a schematic showing an example client device for browsing and accessing query search results using a touch-screen activated interface.

FIG. 3 is a screen shot of an example interface showing graphical representations of query search results in accordance with the present disclosure.

FIG. 4 is an information flow diagram illustrating an example of the flow of information from a front end application to a back end application in a system for processing query searches in accordance with the present disclosure.

FIG. 5 is a block diagram illustrating an example of the information flow of components of the system for processing query searches in accordance with the present disclosure.

FIG. 6 is a process flow diagram illustrating an example process for processing a query search.

FIG. 7 is a process flow diagram describing the operations involved in processing query searches and graphically displaying updateable search results.

FIG. 8 is a process flow diagram illustrating an embodiment process for providing updateable thumbnails of search results to a client device in accordance with the present disclosure.

FIG. 9 is a process flow diagram illustrating an embodiment process for processing modified files received from a client device in accordance with the present disclosure.

FIG. 10 illustrates a process flow diagram illustrating an embodiment process for generating reports or other documents based on search queries.

### DETAILED DESCRIPTION

This disclosure generally relates to displaying, on a display of a client device, one or more dynamically updateable or near real-time, interactive images representing the results of a search query. A user operating a device having a graphical display may enter a query for, as an example, reports that the user is interested in viewing and/or accessing for manipulation. The query, which may be a search string, is processed by evaluating documents and other file types within one or more repositories accessible by the user. The client device is provided thumbnail screen shot images of the documents or other files, which the user may select or click on to open, and view, and manipulate the document. The thumbnail screen shot may display or contain information about the file in graphical form for the user to view. This allows the user to see whether the file is of the type he or she is searching for, and may also provide sufficient information for the user to identify the precise document responsive to the user's query.

The images displayed on the client device may be live or up-to-date thumbnail images of the document or file that may represent the document or may represent the specific part of the document germane to the search query. The client display may show multiple of such thumbnails if more than one document or set of documents satisfies the query. The client device would continuously request updated information based on the query and the query results to update the thumbnail images displayed on the client device. For example, if the user were searching for a report, the system would search for reports across all accessible applications (i.e., the entire application space) matching the search criteria. Metadata associated with each report may be processed to derive information needed to display a thumbnail representative of the an image associated with, for example, a report or other application-specific file type. The thumbnail image of the report is displayed to the user. A user may then click on the thumbnail through the user interface (i.e., keyboard, mouse, touch-screen, etc.) to access the report. A single report may have more than one representative images, as indicated by the metadata. As such, reports having multiple options for thumbnail representations may be displayed as a stack of thumbnails, each stack being browsable by the user, and each thumbnail in each stack providing the user access to the corresponding section of the report. The reports may include annotations, which may be displayed to the user. For example, each thumbnail or stack may include a star rating. The star rating may indicate objective or subjective information about the report or stack to the user. In addition, annotations may represent the likelihood of relevance based on a comparison (i.e., statistical, historical) of the search query to the number of times a document is opened for that query or class of query.

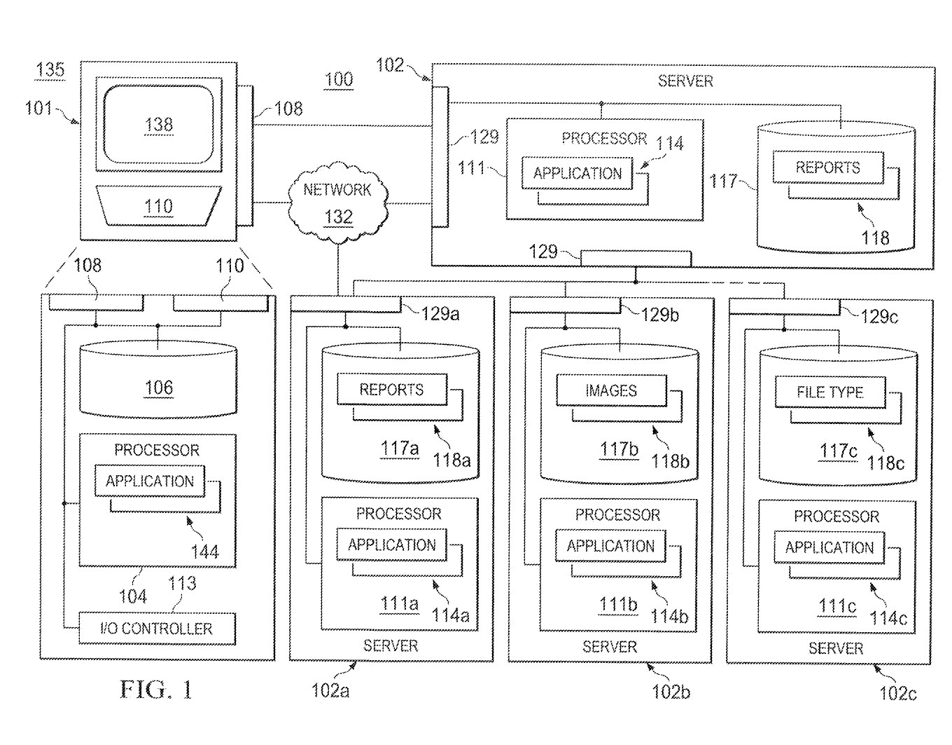

Turning to the example implementation of FIG. 1, the illustrated environment 100 includes, or is communicably coupled, with server 102 and one or more clients 135, at least some of which communicate across network 132. Client 135 may include a client device 101, as well as other elements, as described in more detail below. In general, environment 100 depicts an example configuration of a system capable of receiving and processing search queries and providing to a client device 101 one or more updateable thumbnail images representative of the files satisfying the search parameters. Environment 100 is also capable of receiving and processing requests for access to the files satisfying the search parameters, and providing such access to said files, including displaying images, running applications, and providing interactive user interface to manipulate the file.

In general, the server 102 is any server that stores one or more hosted applications 114, where at least a portion of the hosted applications 114 are executed via requests and responses sent to users or clients within and communicably coupled to the illustrated environment 100 of FIG. 1. In some instances, the server 102 may store a plurality of various hosted applications 114, while in other instances, the server 102 may be a dedicated server meant to store and execute only a single hosted application 114. In some instances, the server 102 may comprise a web server, where the hosted applications 114 represent one or more web-based applications accessed and executed via network 132 by the clients 135 of the system to perform the programmed tasks or operations of the hosted application 114. At a high level, the server 102 comprises an electronic computing device operable to receive, transmit, process, store, or manage data and information associated with the environment 100. Specifically, the server 102 illustrated in FIG. 1 is responsible for receiving application requests from one or more client applications 144 associated with the clients 135 of environment 100 and responding to the received requests by processing said requests in the associated hosted application 114, and sending the appropriate response from the hosted application 114 back to the requesting client application 144. In addition to requests from the external clients 135 illustrated in FIG. 1, requests associated with the hosted applications 114 may also be sent from internal users, external or third-party customers, other automated applications, as well as any other appropriate entities, individuals, systems, or computers. As used in the present disclosure, the term “computer” is intended to encompass any suitable processing device. For example, FIG. 1 illustrates a single server 102, environment 100 can be implemented using two or more servers 102a-c, as well as computers other than servers, including a server pool. Indeed, server 102 may be any computer or processing device such as, for example, a blade server, general-purpose personal computer (PC), Macintosh, workstation, UNIX-based workstation, or any other suitable device. In other words, the present disclosure contemplates computers other than general purpose computers, as well as computers without conventional operating systems. Further, illustrated server 102 may be adapted to execute any operating system, including Linux, UNIX, Windows, Mac OS, or any other suitable operating system. According to one embodiment, server 102 may also include or be communicably coupled with a mail server.

In the present implementation, and as shown in FIG. 1, the server 102 includes a processor 111, an interface 129, a memory 117, and one or more hosted applications 114. The interface 129 is used by the server 102 for communicating with other systems in a client-server or other distributed environment (including within environment 100) connected to the network 132 (e.g., client 135, as well as other systems communicably coupled to the network 132). Generally, the interface 129 comprises logic encoded in software and/or hardware in a suitable combination and operable to communicate with the network 132. More specifically, the interface 129 may comprise software supporting one or more communication protocols associated with communications such that the network 132 or interface's hardware is operable to communicate physical signals within and outside of the illustrated environment 100.

Generally, the network 132 facilitates wireless or wireline communications between the components of the environment 100 (i.e., between the server 102 and the clients 135), as well as with any other local or remote computer, such as additional clients, servers, or other devices communicably coupled to network 132 (inclusive of elements not illustrated in FIG. 1). The network 132 is illustrated as a single network in FIG. 1, but may be a continuous or discontinuous network without departing from the scope of this disclosure, so long as at least a portion of the network 132 may facilitate communications between senders and recipients. The network 132 may be all or a portion of an enterprise or secured network, while in another instance at least a portion of the network 132 may represent a connection to the Internet. In some instances, a portion of the network 132 may be a virtual private network (VPN), such as, for example, the connection between the client device 101 and the server 102. Further, all or a portion of the network 132 can comprise either a wireline or wireless link. Example wireless links may include 802.11a/b/g/n, 802.20, WiMax, and/or any other appropriate wireless link. In other words, the network 132 encompasses any internal or external network, networks, sub-network, or combination thereof operable to facilitate communications between various computing components inside and outside the illustrated environment 100. The network 132 may communicate, for example, Internet Protocol (IP) packets, Frame Relay frames, Asynchronous Transfer Mode (ATM) cells, voice, video, data, and other suitable information between network addresses. The network 132 may also include one or more local area networks (LANs), radio access networks (RANs), metropolitan area networks (MANs), wide area networks (WANs), all or a portion of the Internet, and/or any other communication system or systems at one or more locations.

As illustrated in FIG. 1, server 102 includes a processor 111. Although illustrated as a single processor 111 in FIG. 1, two or more processors may be used according to particular needs, desires, or particular embodiments of environment 100. Each processor 111 may be a central processing unit (CPU), a blade, an application specific integrated circuit (ASIC), a field-programmable gate array (FPGA), or another suitable component. Generally, the processor 111 executes instructions and manipulates data to perform the operations of server 102 and, specifically, the one or more plurality of hosted applications 114. Specifically, the server's processor 111 executes the functionality required to receive and respond to requests from the clients 135 and their respective associated client applications 144, as well as the functionality required to perform the other operations of the hosted application 114. Regardless of the particular implementation, “software” may include computer-readable instructions, firmware, wired or programmed hardware, or any combination thereof on a tangible (non-transient) medium operable when executed to perform at least the processes and operations described herein. Indeed, each software component may be fully or partially written or described in any appropriate computer language including C, C++, Java, Visual Basic, assembler, Perl, any suitable version of 4GL, as well as others. It will be understood that while portions of the software illustrated in FIG. 1 are shown as individual modules that implement the various features and functionality through various objects, methods, or other processes, the software may instead include a number of sub-modules, third-party services, components, libraries, and such, as appropriate. Conversely, the features and functionality of various components can be combined into single components as appropriate. In the illustrated environment 100, processor 111 executes one or more hosted applications 114 on the server 102.

At a high level, each of the one or more hosted applications 114 is any application, program, module, process, or other software that may execute, change, delete, generate, or otherwise manage information according to the present disclosure, particularly in response to and in connection with one or more requests received from the illustrated clients 135 and their associated client applications 144. In certain cases, only one hosted application 114 may be located at a particular server 102. In others, a plurality of related and/or unrelated hosted applications 114 may be stored at a single server 102, or located across a plurality of other servers 102, as well. In certain cases, environment 100 may implement a composite hosted application 114. For example, portions of the composite application may be implemented as Enterprise Java Beans (EJBs) or design-time components may have the ability to generate run-time implementations into different platforms, such as J2EE (Java 2 Platform, Enterprise Edition), ABAP (Advanced Business Application Programming) objects, or Microsoft's .NET, among others. Additionally, the hosted applications 114 may represent web-based applications accessed and executed by remote clients 135 or client applications 144 via the network 132 (e.g., through the Internet). Further, while illustrated as internal to server 102, one or more processes associated with a particular hosted application 114 may be stored, referenced, or executed remotely. For example, a portion of a particular hosted application 114 may be a web service associated with the application that is remotely called, while another portion of the hosted application 114 may be an interface object or agent bundled for processing at a remote client 135. Moreover, any or all of the hosted applications 114 may be a child or sub-module of another software module or enterprise application (not illustrated) without departing from the scope of this disclosure. Still further, portions of the hosted application 114 may be executed by a user working directly at server 102, as well as remotely at client 135.

The server 102 also includes memory 117. Memory 117 may include any memory or database module and may take the form of volatile or non-volatile memory including, without limitation, magnetic media, optical media, random access memory (RAM), read-only memory (ROM), removable media, or any other suitable local or remote memory component. Memory 117 may store various objects or data, including classes, frameworks, applications, backup data, business objects, jobs, web pages, web page templates, database tables, repositories storing business and/or dynamic information, and any other appropriate information including any parameters, variables, algorithms, instructions, rules, constraints, or references thereto associated with the purposes of the server 102 and its one or more hosted applications 114. For example, memory 117 may store reports 118. Additionally, memory 117 may include any other appropriate data, such as VPN applications, firmware logs and policies, firewall policies, a security or access log, print or other reporting files, as well as others.

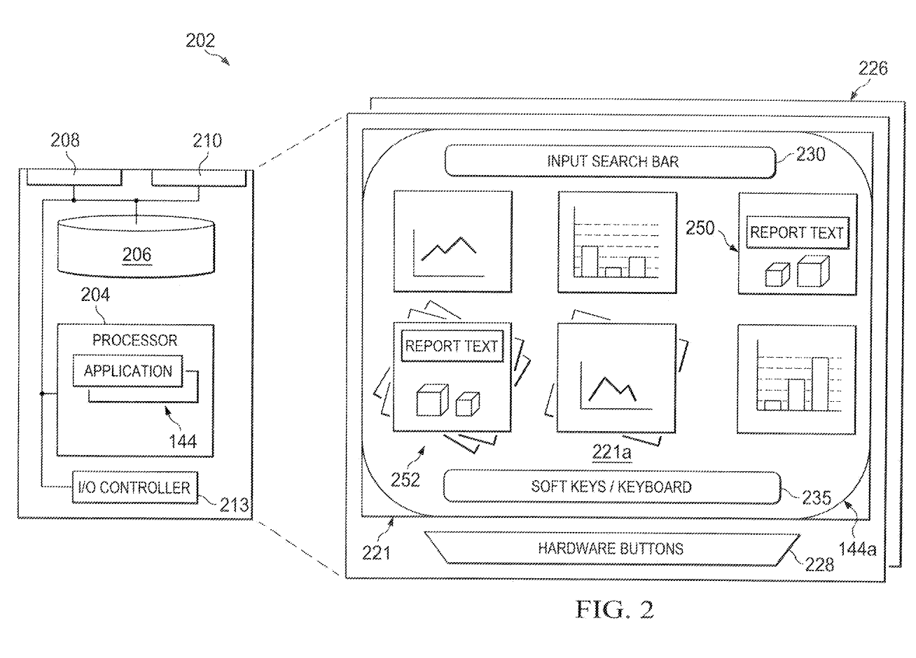

The illustrated environment of FIG. 1 also includes one or more clients 135. Each client 135 may be any computing device operable to connect to or communicate with at least the server 102 and/or via the network 132 using a wireline or wireless connection. In embodiments, client 135 may include a client device 101, such as a computer (PC, Mac, etc.), a portable device, such as a smart phone, iPhone, Blackberry, PDA, etc., a tablet PC such as an iPad, or other such device. In embodiments, client device 101 may be a touch screen device, such as an iPad or iPhone or other similar device, as illustrated by example client device 202 in FIG. 2. Further, as illustrated by client 135, each client device 101 includes a processor 104, an input interface 110, a user interface (UI) 138 (such as a graphical user interface), one or more client applications 144, an input/output controller 113, and a memory 106. In general, each client 135 comprises an electronic computer device 101 operable to receive, transmit, process, and store any appropriate data associated with the environment 100 of FIG. 1. It will be understood that there may be any number of clients 135 associated with, or external to, environment 100. For example, while illustrated environment 100 shows a single client, alternative implementations of environment 100 may include more than one client 135 communicably coupled to the server 102, or any other number suitable to the purposes of the environment 100. Additionally, there may also be one or more additional clients 135 external to the illustrated portion of environment 100 that are capable of interacting with the environment 100 via the network 132. Further, the term “client” and “user” may be used interchangeably as appropriate without departing from the scope of this disclosure. Moreover, while each client 135 is described in terms of being used by a single user, this disclosure contemplates that many users may use one computer, or that one user may use multiple computers. As used in this disclosure, client device 101 is intended to encompass a personal computer, touch screen terminal, workstation, network computer, kiosk, wireless data port, smart phone, personal data assistant (PDA), one or more processors within these or other devices, or any other suitable processing device. For example, each client 135 may comprise a computer that includes an input device, such as a keypad, touch screen, mouse, or other device that can accept user information, and an output device that conveys information associated with the operation of the server 102 (and hosted application 114) or the client 135 itself, including digital data, visual information, the client application 144, or the GUI 138. Both the input and output device may include fixed or removable storage media such as a magnetic storage media, CD-ROM, or other suitable media to both receive input from and provide output to users of the clients 135 through the display, namely, the GUI 138. The administrator (not shown) can modify various settings associated with one or more of the other clients 135, the server 102, the hosted application 114, and/or any relevant portion of environment 100. For example, the administrator may be able to modify the relevant timeout values associated with each hosted application 114, as well as any of the set of hosted application settings. The administrator may be a computer communicably coupled to server 102 and may control client's 135 access rights to information and applications on server 102 as well as on servers 102a-c.

FIG. 1 provides one example of a client device 101. Environment 100 may include a client device 101, such as a touch screen device 202 (see FIG. 2), a network 132, and a server 102. In some instances, neither the network 132 nor the server 102 may be a part of the environment 100, or may be otherwise unnecessary, such as when the client device 101 does not have an available connection to the network 132, as well as when the device's 101 operations are performed locally. The client device 101 and the server 102 can communicate across network 132, where applicable. In general, environment 100 depicts an example configuration of a system capable of visualizing, viewing, selecting, and defining an interval of values for use with a software application, database, or other set of data.

Client device 101 may include a network interface 108. The interface 108 is used by the client device 101 for communicating with other systems in a client-server or other distributed environment (including within environment 100) connected to the network 132 (e.g., client 135, as well as other systems communicably coupled to the network 132, such as server 102 and server 102a). Generally, the interface 108 comprises logic encoded in software and/or hardware in a suitable combination and operable to communicate with the network 132. More specifically, the interface 108 may comprise software supporting one or more communication protocols associated with communications such that the network 132 or interface's hardware is operable to communicate physical signals within and outside of the illustrated environment 100.

Further, the illustrated client device 101 includes a user interface (UI) that, in embodiments, includes a graphical user interface 138 (GUI) operable to interface with at least a portion of environment 100 for any suitable purpose, including generating a visual representation of the client application 144 (in some instances, the client's web browser) and the interactions with the hosted application 114, including the responses received from the hosted application 114 received in response to the requests sent by the client application 144. In embodiments, host application(s) 114 or 114a-c may be graphically displayed on client device 101 through a web application or other emulation program. Generally, through the GUI 138, the user is provided with an efficient and user-friendly presentation of data provided by or communicated within the system. The term “graphical user interface,” or GUI, may be used in the singular or the plural to describe one or more graphical user interfaces and each of the displays of a particular graphical user interface. Therefore, the GUI 138 can represent any graphical user interface, including but not limited to, a web browser, touch screen, or command line interface (CLI) that processes information in environment 100 and efficiently presents the information results to the user. In general, the GUI 138 may include a plurality of user interface (UI) elements, some or all associated with the client application 144, such as interactive fields, pull-down lists, and buttons operable by the user at client 135. These and other UI elements may be related to or represent the functions of the client application 144, as well as other software applications executing at the client 135. In particular, the GUI 138 may be used to present the client-based perspective of the hosted application 114, and may be used (as a web browser or using the client application 144 as a web browser) to view and navigate the hosted application 114, as well as various web pages located both internal and external to the server, some of which may be associated with the hosted application 114. For purposes of the present location, the GUI 138 may be a part of or the entirety of the client application 144, while also merely a tool for displaying the visual representation of the client and hosted applications' 114 actions and interactions. In some instances, the GUI 138 and the client application 144 may be used interchangeably, particularly when the client application 144 represents a web browser associated with the hosted application 114.

FIG. 2 is an illustration of an example touch-device consistent with the present disclosure. In general, the touch device 202 can comprise any computer or other processing device which executes or displays information associated with one or more applications, and which receives and processes input from at least one touch-based (or multi-touch-based) gesture. Additionally, the touch device 202 is capable of receiving touch input based on multiple finger gestures simultaneously applied onto the touch screen 221 of the device 202. Different types of multi-touch devices 202 may be used in accordance with the present disclosure. For example, different size multi-touch devices 202 may be used, as well as touch devices 202 where the touch screen 221 is in a separate housing or structure than the processing portions of the device 202. In the current environment 100, the touch device 202 is considered to be located in a single housing enclosing both the touch screen 221 and the various internal processors, memory, and other components of the touch device 202. In some instances, the touch screen 221 may be a liquid crystal display (LCD). Further, the touch screen 221 may recognize touch-based inputs based on electrical conductivity, relative pressure from a touch, using light-sensitive sensors to determine contacts to the touch screen 221, as well as any other suitable touch input mechanism or combination thereof. In embodiments, touch device 202 may be a multi-touch device. Examples of multi-touch devices 202 include Apple's iPhone smartphone and iPad tablet device, Google's Nexus One smartphone, HTC's Hero, Legend, and Desire smartphones, Microsoft's Zune HD media device, Palm's Pre smartphone, Motorola's Droid smartphone, as well as numerous other consumer and/or business-related devices and accessories capable of receiving and processing multi-touch inputs.

In the implementation illustrated in FIG. 2, the touch device 202 includes a processor 204, a memory 206, a network interface 208, an input/output interface 210, an input/output controller 213, at least one application 144, and a graphical user interface 221a. The network interface 208 is used by the touch device 202 for communicating with other systems, computers, or devices within or external to environment 100, such as through the multi-touch device's 202 connection to the network 132. Generally, the network interface 108 comprises logic encoded in software and/or hardware in a suitable combination and operable to communicate with the network 132. More specifically, the network interface 208 may comprises software supporting one or more communication protocols associated with communications such that the network 132 or hardware is operable to communicate physical signals within and outside of the illustrated environment 100.

FIG. 2 further illustrates an example of the external design of the touch device 202. As illustrated, the touch device 202 includes a case 226, a touch screen 221 for displaying information and through which touch input is entered (described above), a set of permanent hardware buttons 228, a set of soft keys or a software-based keyboard 235, an application window 144a displaying at least a portion of an executing application 144 (e.g., web-based application). The case 226 may comprise any materials or structure housing the various portions of the touch device 202. Additionally, the case 226 may provide a functional or ornamental bezel surrounding the touch screen 221 and hardware buttons 228. The hardware buttons 228 may be any buttons included with the touch device 202, including a power button, a volume button, a physical keyboard, a back button, a home button, or any other physical button or key used in the operation of the device 202. The application window 144a comprises at least a portion of the GUI 221a used to display visual output and/or information associated with a particular executing operation or application. It will be understood that in some implementations, multiple instances of application windows 114a associated with the same or different applications or operations may be presented simultaneously on the GUI 221a. Additionally, the touch device 202 may allow for application windows 144a to be tiled, stacked, hidden, or otherwise moved and manipulated, for example, through specific touch and/or multi-touch gestures, as well as through manipulation of the hardware buttons 228 or soft keys (or software-based keyboard) 235.

Returning to the client device 202, a set of soft keys and/or a software-based keyboard 235 may also be presented on the GUI 221a. These software-based inputs allow for application- and/or operation-specific buttons and inputs to be presented in a particular application or operation context. For instance, an interactive form may include a “finish” button that is only provided when the application is in process or is completed. The soft keys and software-based keyboard 235 can be located in a particular position on the GUI 221a, or may be moveable around the GUI 221a through touch gestures. Furthermore, some applications and software may have buttons embedded or included within the application window 144a, which can be activated through a touch gesture in the appropriate location on the touch screen 221. In one example, a software-based keyboard 235 may be hidden during web browsing until a text box or other text-based input is needed or requested.

Touch device 202 may run query search applications that permit the user to enter search strings into, for example, input search bar 230. Processor 204 may process the search string or may transmit the search string over network 132 to server 102 for processing in processor 104 (shown in FIG. 1). Similarly, device 202 may communicate the search string over network 132 to one or more of server 102a-c, communicating with server 102 or network 132 through interfaces 129a-c, respectively. As shown in FIG. 1, server 102a includes memory 117a, which stores reports 118a. Server 102a also includes processor 111a that can execute application 114a corresponding to the data type or data types associated with reports 118a. In embodiments, memory 117a may store more than one file type (i.e., reports of different file types as well as images of different file types). Likewise, processor 111a may execute any applications stored on server 102a and such applications may correspond to the plurality of file types stored in memory 117a. FIG. 1 merely presents illustrative examples. Similarly, server 102b includes memory 117b, which stores images 118b. Server 102b also includes processor 111b that can execute application 114b corresponding to the data type or data types associated with images 118b. Server 102c includes memory 117c, which stores information corresponding to file type 118c. Server 102c also includes processor 111c that can execute application 114c corresponding to the data type or data types associated with file type 118c. Processor 111 or processor 204 of FIG. 2 may process the search string by parsing the search string into term or by performing look-ups in memory 117. Other known methods of processing search queries are contemplated by this disclosure and would be understood by those of skill in the art. Similarly, processor 204 or processor 111 may search one of memories 117a-c or may communicate the search query to processor 111a-c for processing and searching. It is to be understood that the search for results based on the search string is performed across the entire application space based on user information (e.g., user subscription, license, authorization, credentials, security level, etc.).

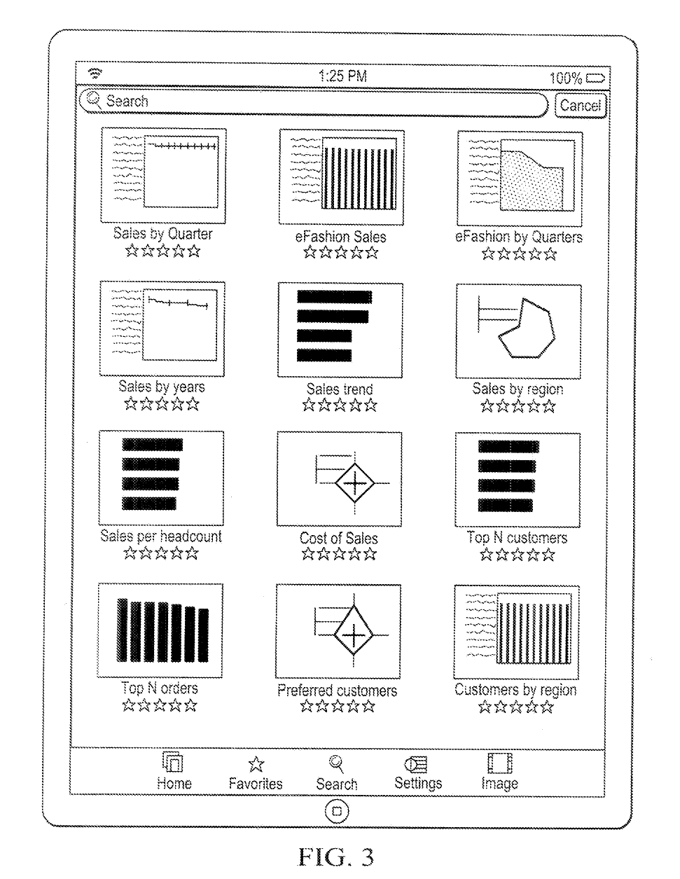

Upon completion of a search, touch device 202 may display thumbnails 250 or stacks of thumbnails 252 on GUI 221a, as illustrated in FIG. 2 and as shown in screen shot of FIG. 3. Thumbnail 250 is a graphical representation of the report, document, image, or other file type returned by the system based on the input search query. The thumbnail 250 provides access to the document or other file type represented, such as through a hyperlink to the represented document whether internal or external to the client. For example, the user may click on the thumbnail to open the file. Opening the file may include executing an application associated with the file type. The application may be an application 144 local to the client device 202 or may be a remote application 114 run on a server 102 and displayed to the client on a web browser or emulation (e.g., green screen emulation or Citrix style program or through a virtual private network) across a network 132. In embodiments, client device 101 is a multi-touch device, similar to touch device 202. In such embodiments, the user may access the file by performing multi-touch gestures on the thumbnail to open the file. Opening the file may take the form of expanding the thumbnail to the window size to display the file. Multi-touch gestures may also be used to close the file to return to the search-results screen (shown in FIG. 3). Once a file is open, the user can view and/or manipulate the file based on his or her user access rights. The user may also annotate the file based on objective and/or subjective information. Annotations may take the form of text comments, star ratings, or other text-based or graphical annotations. Likewise, the system may annotate the document based on the user opening the file, and comparing the search query to data and metadata associated with the file. Such a comparison may be stored in memory associated with that file.

For example, if a user enters a search string “financial reports for 1991,” the system may search through the entire application space associated with the user and return on the display graphical representations (thumbnails) of the file types it finds. If a user opens a particular file type, the system may associate the search string with that file type, the file data, and/or the file metadata. The system may then annotate the file to generate relevancy percentage ratings based on an aggregation of statistical data for that file type. In embodiments, the system may count the number of times a particular file is opened and associate that file with the search string resulting in its display. The system may return the same file type based on multiple search strings. Thus, a relevancy percentage may permit the user to refine the search to more accurately locate particular file types. In embodiments, the system may also be a semantic system. A particular file type may be returned with a higher relevancy based on the frequency a user enters a particular search string. Or the system may decline to return a particular file based on the user failing to open the file type and re-entering a different search string. Permutations of this semantic architecture are contemplated by this disclosure and would be readily apparent to those of skill in the art.

In embodiments, touch or multi-touch gestures may be used to browse through stacks of thumbnails 252 or to zoom in onto a region of interest in the results screen to view multiple thumbnails in closer perspective to see more detail. Displaying interactive and updatable thumbnails representing search results permits a user to preview, browse, and/or access particular files and file types without having to open files, resulting in more efficient searching. In addition, thumbnails 250 may be representative of reports generated based on data resulting from the search query.

The thumbnails 250 are generated by the application server corresponding to the file or by the processor that accesses and/or displays the thumbnail to the user. The thumbnail is generated by processing metadata of the file. The metadata permits the thumbnail to represent the file graphically while also providing the user with the actual data that is presented in the file. For example, a report that presents a pie chart to the user would include metadata providing information about the pie chart that would allow the processor to reproduce that data in thumbnail form. Other information may be reproduced in a similar manner or by any manner known to those of skill in the art. For example, text, such as headings or titles, images, graphs, spreadsheets, or any other data or information that is available and displayed visually to a user may be reproduced in the thumbnail. Likewise, the thumbnails 250 may display the user interface (i.e., graphical user interface) for the resulting file type. For example, if the user is browsing for a form or set of forms, the thumbnail may show the user the user interface for the form or for the form type he or she is searching for.

Further, the system may update the thumbnail by reprocessing the metadata or other data and adjust the thumbnail according to any changes to the visual representation of the file. For example, if another user changes the title of the document, the system would update the thumbnail to show such a change. The refresh rate for the thumbnail images (not to be confused with any refresh rates for the display itself) may be at a predetermined interval. Such an interval may be determined by the user or by an administrator or by other means. Refresh rates may be unique to each server and/or file type displayed. For example, refresh rates may be based on statistical data indicated by the frequency of use for a particular file or file type.

Thumbnails 250 are updated and display up-to-date information to the user. Opening the file also displays up-to-date information. After running a search and displaying one or more thumbnails 250, the client device may continuously request updates for the files displayed on the display of device 202. As such, the thumbnails are refreshed based on the timing of changes to the file. Such changes may include deletions, additions, color changes, analytical or statistical updates, or any other alterations to the data associated with the file type.

Returning to the block diagram of the environment 100 in FIG. 1, the network 132 can allow the client device 101 to communicate with the server 132 and at least a portion of the functionality provided by the server 132. Further, network 132 can allow the client device 101 to communicate with any of servers 102 and 102a-c. At a high level, the server 102 comprises an electronic computing device operable to receive, transmit, process, store, or manage data and information associated with the environment 100. In general, server 102 may be any computer or processing device such as, for example, a blade server, general-purpose personal computer (PC), Macintosh, workstation, Unix-based computer, or any other suitable device. In other words, the present disclosure contemplates computers other than general purpose computers, as well as computers without conventional operating systems. Illustrated server 122 may be adapted to execute any operating system including Linux, UNIX, Windows Server, or any other suitable operating system. In some instances, such as that illustrated in FIG. 1, the server 102 hosts or executes a web-based application which can then be viewed or interacted with at the touch device 202 via the touch device's GUI 221a. Input and interactions at the touch device 202 can be interpreted and relayed to the web-based application in accordance with the host applications' 114 functionality and processing. The web-based application can be any suitable application, including web- or cloud-based portions of a business application, such as an enterprise resource planning (ERP) system.

While FIGS. 1 and 2 are described as containing or being associated with a plurality of elements, not all elements illustrated within environment 100 of FIG. 1 or device 202 of FIG. 2 may be utilized in each alternative implementation of the present disclosure. Additionally, one or more of the elements described herein may be located external to environment 100, while in other instances, certain elements may be included within or as a portion of one or more of the other described elements, as well as other elements not described in the illustrated implementation. Further, certain elements illustrated may be combined with other components, as well as used for alternative or additional purposes, in addition to those purposes described herein.

The following paragraphs provide an example of how the system, methods, and software of the present disclosure may perform searches across an application space, which was described in SAP Patent Application 2007/0027876 filed Jul. 29, 2005, incorporated by reference herein. A business information system can improve an organization's ability to monitor and manage data in a complex business environment. A business information system, such as the SAP Business Intelligence (“BI”) systems offered by SAP AG of Walldorf, Germany, provides components and tools that allow users to retrieve, view and manipulate data from a number of different sources. Some items of data may be from internal sources (e.g., such as a company's internal database), while others may be from external or third-party sources. As used herein, a company's “internal data” is data that is stored and maintained as part of the company's overall business intelligence solution. Some of the data, for example, may be associated with a “data warehouse” (generally referred to herein as a “business warehouse” or “BW”). The BW may be a combination of business information stored in a variety of ways, including in a relational database, in memory databases, in data storage areas remote from the enterprise application systems and in virtual data sources (such as ad hoc data generated from business coding in the BW). As used herein, “external data” is data that is not processed or maintained by the analytical engine of the business information system.

A BW may include preconfigured data formats and conventions. As a result, it is relatively straightforward to query, view, and manipulate “internal data”. It can be more difficult, however, for a business information system to process requests, queries, or other interactions with external data or data from external data sources or other applications. For example, external data is typically formatted or configured differently from the internal data. One example of a type of transaction which is made more difficult by the need to access both internal and external data is the execution of a query to retrieve specified data. Business information systems typically provide some capability for users of the system to submit a query to retrieve and view data.

A “query view” is a definition of desired data, including a definition of what data to look for and how to arrange and format the data. The query view represents all of the settings an end user client application requires to provide the data to the end user. For example, a query view typically includes restrictions (or filters) that are applied to the data to be accessed. Specific illustrative examples are: product lines, company names, customer groups, fiscal year, distribution regions, product costs, product quantities, revenues, dates, etc. Data filters may be applied to further limit the result data. For example, result data can be filtered to identify illustrative features such as: the customers having revenue greater than 1 million dollars, the top 10 customers according to revenue, the customers having actual derivation to plan of greater than 5%, etc. Query views may further include visualization settings to more efficiently display and format retrieved data. For example, visualization settings may include traffic light reporting or calculations based on the retrieved data (such as ranking calculations), or the like. By providing such settings, the retrieval of data becomes more efficient and focused to a user's particular needs.

In existing systems, a query is generally executed by a query application (the “called application”) which is called by another application (the “calling application”) that will analyze the retrieved query data and add client applications on top of the retrieved query data. The query view is generally defined in a format native to the calling application rather than to the called application. As such, the calling application must include a translator to convert the query view into a format native to the called application. Such an approach, however, can become cumbersome, particularly when there are several different applications in a business information system that include query views, since each application has to have its own translator. In this case, a developer must know how to translate query views from each application's format to the format of the called application and then create all the translators. This is costly and time-consuming.

Some systems use Microsoft XMLA for data retrieval. However XMLA/MDX only describes the data retrieval part in a structured query language (SQL)-like manner. Therefore, calling applications typically have their own model on top of it and generate XMLA/MDX for data access based on their model. The generation of XMLA/MDX may be complicated, because XMLA/MDX is generic and geared toward academia and many business questions result in very complex MDX code (where MDX is the query language of XMLA/ODBO). Concepts such as traffic light reporting, currency translation, complex currency and unit handling, or inactive parts of the definition are missing completely. These features have to be enhanced (if possible) by the calling application.

In embodiments, an information provider model and architecture are provided that allow different information sources to easily interface with and supply information to a business information system. In embodiments, the details about different information providers, including details about the information provider's data formats and content, are hidden from a user of the system. In embodiments, information providers are not forced to comply with the business information system's format, features or terminology. Instead, embodiments allow information providers to simply notify the system of the provider's data model and capabilities. A consumer services layer associated with the system operates to enrich or enhance the provider data to provide additional features such as exception reporting, list calculation, or the like.

For convenience and ease of exposition, a number of terms are used herein to illustrate features of embodiments of the present invention. For example, the term “metadata” is used to refer to data used to describe the contents of a data warehouse or other data source. In general, as used herein, the term metadata refers to data that is not changed by a query or view of the data and is defined by the data source. For example, “metadata” can include business objects such as customers, products, and sales events, or business events (sales orders, purchase orders) or status information (stock values, head counts). Metadata provided by a data source may include information defining the specific characteristics or attributes the metadata item supports.

The metadata of the business information system which will be used to illustrate features of the present invention describes a model of data objects (the “internal data”) that includes: InfoProviders, Queries, InfoObjects (typically characteristics or their display attributes or hierarchy node types) and their members, hierarchies, levels, etc. “External data” providers map their internal metadata to the same metadata model without much (or any) loss of information, because the metadata model is very powerful.

“Characteristics” are types of “InfoObjects” that are used to describe the objects dealt with in business processes. A characteristic can be anything from company codes, products, customer groups, fiscal year, period, or region and provide classification possibilities for a dataset. An InfoProvider generally consists of a set of characteristics. The master data (or info object members) includes the permitted members for a characteristic, referred to as a “characteristic member.” Characteristic members are discrete objects with a unique name (within the info object). As an illustrative example, the characteristic “region” can have the following members: “north,” “south,” “central,” etc.

The description of a characteristic may include “hierarchies.” For example, a characteristic may have a presentation hierarchy assigned to it which is used to structure the members of a characteristic in a hierarchical way. A hierarchy usually has more than one level and the structuring nodes may be info object members of the characteristic itself (bookable nodes), info object members of another info object (to reuse the master data), or may be simple text nodes (special info object in case of BW as a data source). A hierarchy may not be necessarily balanced (where all branches end at the same level) or leveled (where all members on a certain level are derived from the same info object). It is even possible to have no unique nodes that are used multiple times in the hierarchy. Even so, the hierarchy may not be leveled, as the levels may have assigned a language-dependent text.

The “nodes” (including the leaves) of a hierarchy are associated with a node type. The node type provides the reference to the info object to which the node belongs and provides means to describe what presentation type that node should be used with and what attributes are needed (e.g., for presentation in a pivot table or in a chart or for formatted reports).

Pursuant to some embodiments, a consumer services layer is provided to provide access to external and internal data in a more client-oriented manner. Embodiments allow client-oriented features, such as exception reporting (e.g., traffic light reporting) and calculations on a display list, at the consumer services level. Other features such as currency conversion and special types of hierarchies can be described with embodiments disclosed herein.

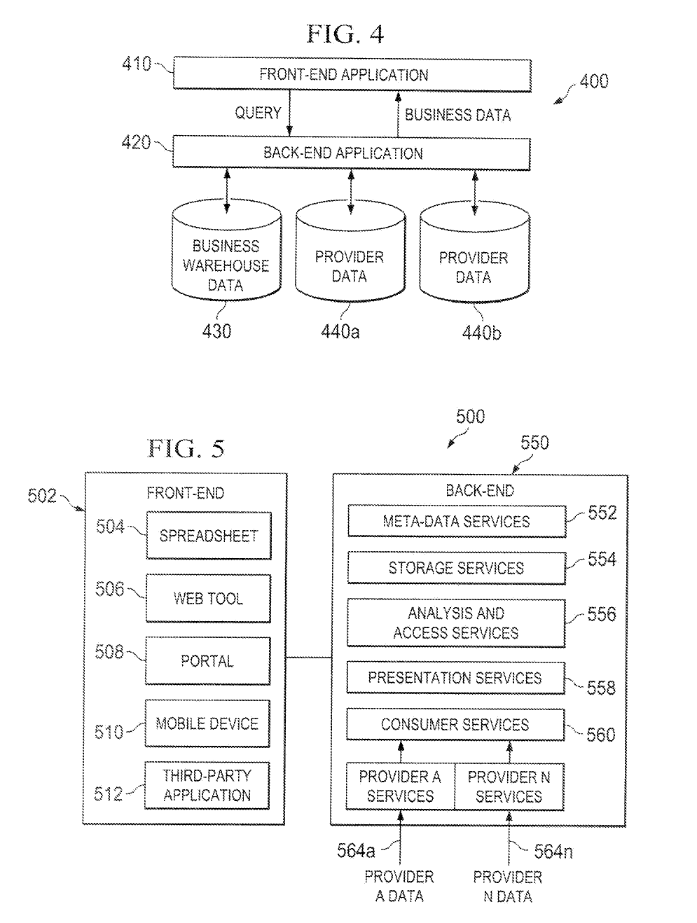

FIG. 4 is an information flow diagram illustrating the use of external data (or, as shown, data from third-party information providers) in connection with a business information system 400. The system 400 includes a back-end application 420. The back-end application 420 might be designed, for example, to store and process a substantial amount of business information associated with an enterprise.

The back-end application 420 may have access to internal data, or, as shown, business warehouse data 430. The application 420 may also have access to external data, or, as shown, data from one or more information providers 440a, 440b. Pursuant to some embodiments, the back-end application 420 retrieves data from information providers 440a, 440b through the use of consumer services in communication with provider services associated with each of the information providers. These services are not shown in FIG. 4 and will be discussed further below. In general, the services operate to transform data from provider formats into formats usable by the system 400. The back-end application 420 may also be associated with or include an online analytical processing (OLAP) processor (not shown). The OLAP processor may facilitate handling of complex data selection expressions for data retrieval.

The system 400 also includes a front-end application 410 that may be accessed by a user. Note that the front-end application 410 may be remote from the back-end application 420 (e.g., the two applications 410, 420 may communicate via a communication network such as the Internet).

The front-end application 410 might be, for example, a spreadsheet application such as the Microsoft Excel spreadsheet program, or a Web server based application for Web clients or any other technology that needs to access BI data for client-like operations. A user may access the front-end application 410 to request particular information, in a particular format, from the back-end application 420. For example, the user might generate a request or “query” asking for weekly inventory information from a number of different regions over the last year. After the data is retrieved by the back-end application 420, it may be formatted as a report and displayed to the user via the front-end application 410.

As one example embodiment, the front-end application 410 is the SAP BI Business Explorer available from SAP AG. The Business Explorer provides a user interface allowing a user to define and submit desired queries and reports using a Web HTML client or a Microsoft Windows client.

FIG. 5 is a block diagram of a business information system 500 including a front-end 502 and a back-end 550. The front-end 502 may be used to construct, submit and view query view data obtained through the back-end 550. For example, a user may create and submit a query view through a spreadsheet application 504, or through some other tools associated with the front-end 502. The query view definition or query view state change commands are transmitted to the back-end 550 and are operated on to cause relevant data to be retrieved from information sources, including internal data sources (not shown) and one or more external or provider data sources (shown as information provider A and information provider N). Users may interact with the data via the front-end 502 using a number of different types of applications, including a spreadsheet application 504, a Web tool 506, a portal 508, a mobile device 210, or a third-party application 512. The interaction is either communicated via state change commands to the backend 550 or the front-end technology directly calls query view APIs for applying the interaction to the query view.

The system 500 also includes a back-end 550 which may store, access and process business information. The back-end 550 might include, for example, one or more consumer services (e.g., consumer query views) 560 to import business data into the system 500 (e.g., external data from one or more information providers). The consumer services 560 allow the tools from the front-end 502 to work with data from information providers and access the data in a unified way for different information providers or sources of data. As will be discussed further below, the consumer services 560 provide client/application-like access to the provider data. Further, the consumer services 560 provide enhanced services, allowing detailed exception reporting, list calculation, document integration, and other services typically unavailable when retrieving data from external or foreign data sources. The consumer services 560 expose an application programming interface (API) that describes the data in each request and provides easy access to the data in the result set. For example, the consumer services 560 may be implemented as a Java. API, although those skilled in the art will appreciate that other languages or conventions may be used.

The consumer services 560 provide queries to and receive result sets from one or more provider services 564a-n. Pursuant to some embodiments, each information provider is associated with a provider service 564. Each provider service includes a provider API that a provider has implemented in order to interface with the consumer services 560. Pursuant to some embodiments, the provider services 564 may be implemented as a Java. API, although those skilled in the art will appreciate that other languages or conventions may be used.

The back-end 550 might also include one or more storage services 554 that store and archive business information. For example, the storage services 554 might provide access to different data targets available in the system 500, archive dormant data, and/or manage relational or multi-dimensional databases. One or more analysis and access services 556 might also be provided in the back-end 550. Such a service 556 might, for example, facilitate an analysis of structured and/or unstructured information stored in the system 500 and may include a data-mining engine. In addition, the back-end 550 may include one or more presentation services 558 to provide different ways of presenting information to an end user. According to some embodiments, the presentation service 558 might include a query design engine, a formatting engine, and/or an Extensible Mark-up Language (XML) interface (e.g., to provide data via a Web portal).

In embodiments, one or more “metadata” services 552 are also provided at the back-end 550. In general, as discussed above, meta-data may refer to, for example, information about business data that is distributed across a landscape of a system's architectural components (e.g., describing what data resides where). The meta-data service 552 might, for example, store meta-data and handle requests to retrieve, add, change, or delete the meta-data. Furthermore the meta-data service 552 might provide uniform information (that can be customized system wide by the user) on how special values, such as division by zero or undefined currency/unit aggregation, should be prepared for presentation in order to guarantee homogeneous presentation of all sources.

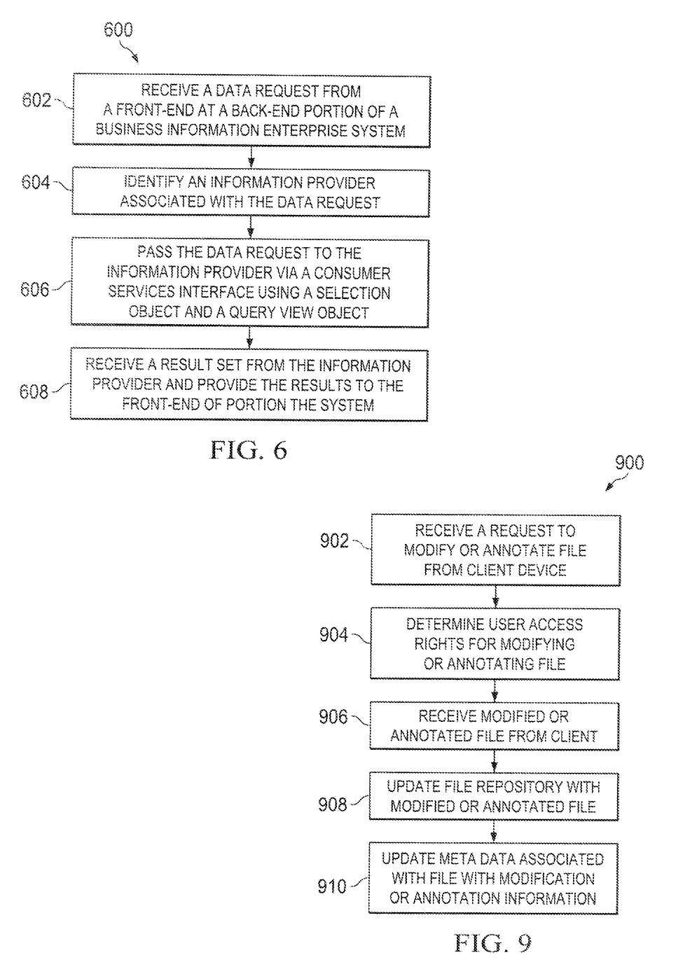

The process of FIG. 6 may commence at 602 where a front-end portion of a business information system receives a data request. For example, the data request may be a query view submitted by a user interacting with a user interface. As an illustrative example, if the business information system is one of the systems offered by SAP AG, the user may submit a query view via the SAP BI Business Explorer application. The back-end portion may receive the request from the front-end portion either (a) to conduct the search defined by the query view, or (b) to execute the query view itself. A processor may facilitate handling of complex query view selections for data retrieval that is later enhanced with the client functions of the consumer services.

Processing continues at 604 where the system identifies an information provider associated with the data request. That is, the data request or query view may require the retrieval of data from one or more external information providers. Processing at 604 includes identifying this situation and identifying the relevant information provider. Processing continues at 606 where the system passes the data request to the information provider via a consumer services interface using a selection object and a query view object. The use of these objects will be described further below. In general, however, the selection object and query view object are used to obtain access to the different kinds of data made available by different information providers and to extend the basic selection information with additional data features such as key figures, axes, conditions, and exceptions that are needed for data access.

Processing continues at 608 where the system receives a result set from the information provider and provides the result set to the front-end portion of the system (e.g., for display to the user). When a provider receives the selection and query view information via its provider API, it performs any OLAP processing needed to generate the result set and passes the result set back to the consumer services interface via the provider API. The consumer services interface then enhances the result set with consumer methods and attributes and performs client functions such as list calculation, exception reporting, and document integration, on top of the provider result set. The enhanced provider result set is then presented to the front-end as a consumer result set for use by the user. Pursuant to some embodiments, the result set is closely linked to the query view and generally cannot be interpreted without the query view. To ensure this linkage is maintained during a query, a state of the query view must be in synch with a state of the result set. If a state change occurs in the query view (e.g., the user attempts to perform some navigation within the results), the result set is automatically invalidated.

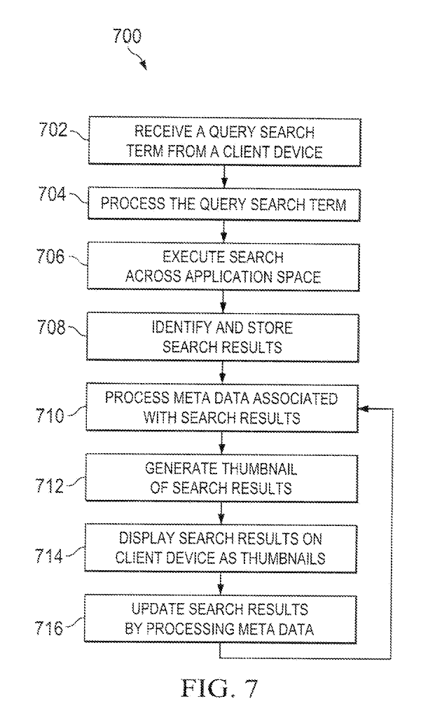

FIG. 7 is a process flow diagram 700 illustrating steps for graphically displaying updateable thumbnail images of query search results. A user may input a search term into a client device, as described above in connection with FIGS. 1-3. The search term may be received by a processor local to the client device or the search term may be communicated to a remote server [702]. The processor may parse the search term [704] or otherwise process the search term. The search is executed based on the search term by searching one or more databases corresponding to applications associated with the user [706]. In other words, the user's subscription, license, access rights, security certificates, etc., are all taken into consideration to establish an application space associated with that user. The entire application space may be searched to return results to the user. Alternatively, the user may specify an application space, a file type, a repository name, a directory, etc., in order to structure the search. The system may identify one or more files that satisfy the search criteria and store the search results in a memory [708]. The system may compile a database of metadata associated with the files that satisfy the search criteria, or the system may extract the files and save them to a local memory or remote server. The metadata associated with the identified files is processed to identify and extract information pertaining to graphical details of the file [710]. Further, the metadata may be processed to extract substantive information and data that may be graphically represented, either as an image or text or other format. A thumbnail image of the file or files is generated based on the metadata for each of the one or more identified files [712]. The thumbnails of the files are then displayed as thumbnails of each of the identified files on the client device [714]. The thumbnails may be updated by reprocessing the metadata and generating a new thumbnail [716]. A new thumbnail may be generated when the system recognizes that the pertinent metadata has been modified. In embodiments, a new thumbnail is generated even if no changes have been identified. The system may reprocess the metadata to provide updated thumbnails at a predetermined interval. In embodiments, the system may update the thumbnails based on a request by the client device. The system may also be responsive to third-party changes to the thumbnailed files, and automatically regenerate the thumbnail of a modified filed upon detection of such a change (such as after notification by or from a back end system).

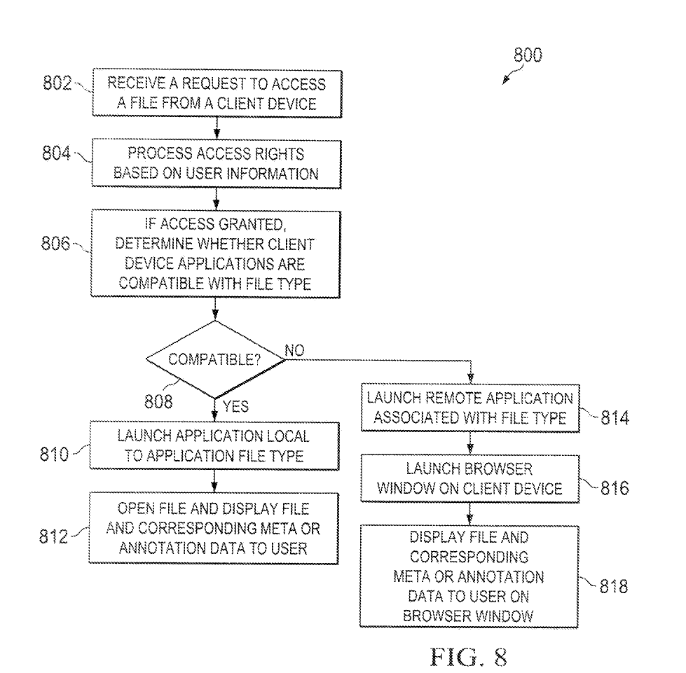

FIG. 8 illustrates a process flow diagram 800 for accessing a file from a thumbnail displayed on a client device. The system may recognize or receive a request for access to a selected file [802]. The system may process the access rights of the user to determine whether the user has permission to view, open, modify, or otherwise access the file and may determine the level of access rights the user has with respect to the selected file [804]. For example, the system may recognize that the user has read only access rights, and would thus not access changes the user attempts to make to the file. If the user has permission to access the selected file, the system may display the file to the user on the client device based on the level of the user's access rights. If the user does not have permission to access the selected file, the system may display an access denied message on the client device.

If the system determines that the user has permission to access the file, the client device may display the selected file based on the compatibility of the applications stored on the client device with the selected file type. In embodiments, the system may determine whether the client device applications are compatible with the file type selected [806]. If the client device can execute a compatible application [808], then the system provides the file to the client device and executes the application [810-812]. If the client device does not have a compatible application, the system may check whether the client device includes a browser with a compatible plug-in to view the selected file [816]. If the client device has a browser with a plug-in or similar software application, the selected file may be displayed to the user on the client device's browser. If the browser does not have a plug-in, the system may indicate such and indicate to the user that a plug-in is available. In embodiments, a private network or virtual private network may be established between the client device and the server. The server may launch an application on the server side to open the program and communicate the file information over a virtual network [814]. The file may then be viewed on the client device either through the browser or over the virtual network [818].

FIG. 9 illustrates a process flow diagram 900 for processing modifications and/or annotations to a selected file. The system may receive a modified file from the client device, the modified file including a modification to a selected file [902]. The system may determine the user access rights to the file: specifically, the system determines whether the user has write access to the particular file [904]. The file may be received by the remote server and stored [906]. The database associated with the file may be updated [908], and the metadata associated with the originally selected file may be updated with information corresponding to the modification [910]. The modification to the file may be displayed graphically as a thumbnail if the file is identified as a potential result of a search query. Such modifications may include annotations, star ratings, objective and/or subjective information; relevancy ratings, etc.

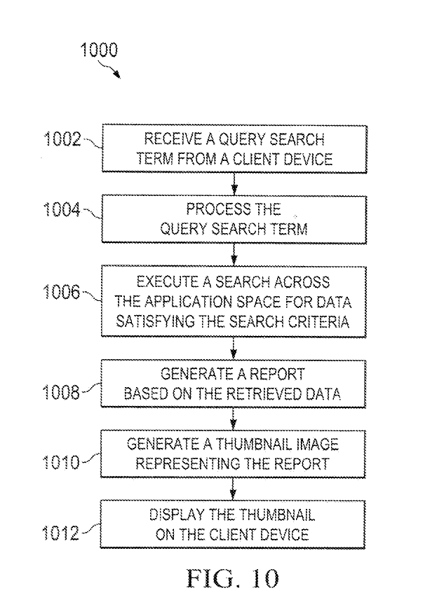

FIG. 10 illustrates a process flow diagram 1000 for generating reports or other documents based on search queries. A user may be interested in viewing a report or viewing data displayed in an organized fashion. A user may use a client device to perform searches for data by entering search terms into a device. The search term may be communicated to a server [1002], which can process the search term to retrieve data satisfying the search criteria [1004]. The system may execute a search across the entire application space associated with the client or client device [1006]. The system may store the retrieved data. Upon completion of processing the search term, the system may generate a report based on the retrieved data [1008]. The data may be aggregated into a single report or into a plurality of reports. The reports may represent the search query. The report (or other document) type may be based on the type of data retrieved. One or more thumbnail images of the one or more reports may be generated [1010] and displayed on the client device [1012]. The thumbnails provide a preview of the reports generated by the search query. The user may open the reports by selecting one of the thumbnails. A user may select a report by clicking on it using a user interface. In embodiments, the client device may support touch or multi-touch gestures for accessing the reports.

Although this disclosure has been described in terms of certain implementation and generally associated methods, alterations and permutations of these implementations and methods will be apparent to those skilled in the art. For example, the actions described herein can be performed in a different order than as described and still achieve desirable results. As one example, the processes depicted in the accompanying figures do not necessarily require the particular order shown, or sequential order, to achieve the desired results. In certain implementations, multitasking and parallel processing may be advantageous. Other variations are within the scope of the following claims.

What is claimed is:

1. A computerized method for graphically displaying search results, the method steps performed by a processor and comprising:
receiving a search query for one or more files in the form of a search term from a client device;
executing a search of one or more databases to identify one or more search results that satisfy the search term;
generating a thumbnail image of each of the one or more identified search results, the thumbnail image generated based at least in part on metadata associated with the one or more identified search results; and
providing the thumbnail image of at least a subset of the one or more identified search results to the client device.

2. The method of claim 1 wherein the search results include one or more reports satisfying the search term, and the thumbnail image of the one or more identified results includes a representation of the one or more reports satisfying the search term.

3. The method of claim 1 further comprising updating at least one thumbnail image displayed on the client device by:
processing at least one update associated with the metadata associated with the one or more identified search results;
generating a new thumbnail image based on the at least one update associated with the metadata; and
upon a request from the client device, providing the new thumbnail image to the client device.

4. The method of claim 1 wherein providing the thumbnail image to the client device comprises:
receiving a request for access to a selected file from the client device, the selected file associated with one or more of the identified search results;
processing access rights associated with the client device to determine whether the client device has permission to access the selected file; and
providing the selected file for display on the client device if the client device has permission to access the selected file.

5. The method of claim 1 wherein providing the thumbnail image to the client device comprises:
determining that the client device includes an application compatible with a file type of a selected file, the selected file associated with one or more of the identified search results; and
communicating the selected file to the client device for display on the application.

6. The method of claim 1 wherein providing the thumbnail image to the client device comprises:
identifying a browser plug-in that is compatible with a file type of a selected file, the selected file associated with one or more of the identified search results;
determining that the client device includes a browser with the browser plug-in; and
communicating data associated with the selected file to the client device for display in the browser.

7. The method of claim 1 wherein providing the thumbnail image to the client device comprises:
establishing a private network between a server hosting a remote application associated with the selected file and the client device, the selected file associated with one or more of the identified search results;
communicating a run-time emulation program to the client device; and
launching the remote application on the server, the remote application compatible with a file type associated with the selected file to display the selected file on the client device.

8. The method of claim 1 further comprising:
receiving a modified file from the client device, the modified file including a modification to a selected file, the selected file associated with one or more of the identified search results;
storing the modified file; and
updating the metadata associated with the selected file with information corresponding to the modification.

9. The method of claim 1 further comprising:
receiving a touch gesture from the client device;
processing the touch gesture by determining one or more operations associated with the touch gesture; and
executing the one or more operations.

10. A system for graphically displaying query results, the system comprising:
a memory; and
at least one processor operable to execute instructions to perform the following:
receive at a server a search query for one or more files in the form of a search term from a client device,
execute a search based on the search term by searching one or more databases,
identify one or more files that satisfy the search term,
generate a thumbnail image of each of the one or more identified files, the thumbnail image generated based at least in part on metadata associated with the one or more identified files, and
provide the thumbnail image of at least a subset of the one or more identified search results to the client device.

11. The system of claim 10 wherein the query results include one or more reports satisfying the search term, and the thumbnail image of the one or more identified files includes a representation of the one or more reports satisfying the search term.

12. The system of claim 10 further operable to update at least one thumbnail image displayed on the client device by:
processing at least one update to the metadata associated with the at least one of the identified one or more files;
generating a new thumbnail; and
upon a request from the client device, displaying the new thumbnail.

13. The system of claim 10 wherein before providing the thumbnail image to the client device, the system is further operable to:
receive a request for access to a selected file from the client device, the selected file associated with one or more of the identified search results;
process access rights associated with the client device to determine whether the client device has permission to access the selected file; and
provide the selected file for display on the client device if the client device has permission to access the selected file.

14. The system of claim 10 wherein before providing the thumbnail image to the client device, the system is further operable to:
receive a request for access to a selected file from the client device, the selected file associated with one or more of the identified search results;
determine that the client device includes an application that is compatible with a file type associated with the selected file; and
communicate the selected file to the client device for display on the application.

15. The system of claim 10 wherein before providing the thumbnail image to the client device, the system is further operable to:
receive a request for access to a selected file from the client device, the selected file associated with one or more of the identified search results;
identify a browser plug-in that is compatible with a file type associated with the selected file;
determine that the client device includes a browser with the browser plug-in; and
communicate data associated with the selected file to the client device for display in the browser.

16. The system of claim 10 wherein before providing the thumbnail image to the client device, the system is further operable to:
receive a request for access to a selected file from the client device, the selected file associated with one or more of the identified search results;
establish a private network between the server and the client device, the server hosting a remote application associated with the selected file and the client device,
communicate a run-time emulation program to the client device; and
launch the remote application on the server, the remote application compatible with a file type associated with the selected file to display the selected file on the client device.

17. The system of claim 10 further operable to:
receive a modified file from the client device, the modified file including a modification to a selected file, the selected file associated with one or more of the identified search results;
store the modified file; and
update the metadata associated with the selected file with information corresponding to the modification.

18. The system of claim 10 further operable to:
receive a touch gesture from the client device;
process the touch gesture by determining one or more operations associated with the touch gesture; and
execute the one or more operations.

19. A computer program product for graphically displaying search results, the computer program product comprising computer readable instructions embodied on tangible, non-transient media and operable when executed to:
receive at a server a search query for one or more files in the form of a search term from a client device;
execute a search based on the search term by searching one or more databases corresponding to applications associated with the client device,
identify one or more files that satisfy the search term,
generate a thumbnail image of each of the one or more identified files, the thumbnail image generated based at least in part on metadata associated with the one or more identified files, and
provide the thumbnail image of at least a subset of the one or more identified files to the client device.

20. The computer program product of claim 19 wherein the thumbnail image of the one or more identified files displays information contained in the one or more files satisfying the search term when displayed on the client device.
